(19) United States
(12) Patent Application Publication
(10) Pub. No.: US 2026/0022051 A1
(43) Pub. Date: Jan. 22, 2026

(54) METHOD AND APPARATUS FOR MANUFACTURING A GLASS BLADE WITH A CUTTING EDGE

(71) Applicant: Razorglass Ltd., Kirby Merseyside (GB)

(72) Inventor: Edward Sweeney, Kirby Merseyside (GB)

(21) Appl. No.: 18/875,743

(22) PCT Filed: Jun. 29, 2023
(86) PCT No.: PCT/GB2023/051698

§ 371 Date: Dec. 17, 2024

(30) Foreign Application Priority Data
Jul. 25, 2022 (GB) 2210841.9

(51) Int. Cl. C03B 33/033; C03B 33/023; C03B 33/03

(52) U.S. Cl. CPC C03B 33/033; C03B 33/0235; C03B 33/03

(57) ABSTRACT

The present invention provides a method for manufacturing blades with a cutting edge from glass by subjecting a strip glass to a controlled breaking force. Before breaking the glass is scored to create a line of weakness at which the break is made. The glass is broken by striking the glass with a breaking force that causes the glass on either side of the score line to pivot away from one another. This controlled breaking of the glass strip creates a broken off portion of glass that has a sharp cutting edge. The present invention also provides an apparatus that creates glass blades in accordance with the method.

### FIELD OF THE INVENTION

The present invention relates to cutting blades formed from glass, and in particular to a method and an apparatus for manufacturing a glass blade.

### BACKGROUND OF THE INVENTION

Throughout history tools with cutting edges have been formed from a range of materials including stone and metal. Metals alloys, such as stainless steel, are commonly used in the formation of cutting blades because of their ability to adopt and maintain a sharp cutting edge.

With continued use over time the initially sharp edge of a cutting blade can eventually be dulled and become less sharp. In many cases, when this happens, the cutting edge of the blade can be resharpened using appropriate techniques.

In the case of metal blades, for example, the cutting edge can be renewed by working the blade's edge on a sharpening stone. However, depending on the nature of the metal cutting blade, it is not always practicable to resharpen a blade's cutting edge.

For example, in the case of metal razor blades, which are typically smaller and harder to handle than knives, it is easier to simply dispose of the old razor blade and replace it with a fresh one. Such disposable razor blades represent a large amount of waste generated each year.

In addition, the material cost of metal is such that metal blades can be expensive. This is keenly felt by consumers of disposable razors/razor heads in particular due to the need to constantly replace the blades rather than resharpen them so that they can be reused.

In view of the disadvantages of metal cutting blades, such as razor blades, there is need to provide alternative forms of cutting blades that are made from materials other than metal and yet still deliver a sharp cutting edge.

### SUMMARY OF THE INVENTION

With a view to offering alternative forms of cutting blades, the present invention provides a method of manufacturing a glass blade with a cutting edge in accordance with claim 1 and a glass blade formed using the manufacturing method of the present invention according to claim 14. The present invention also provides an apparatus for use in the manufacture of glass blades in accordance with claim 15.

It is appreciated that cutting blades formed from glass offer an economical alternative to metal blades, that has a well-established waste recycling pathway. The manufacturing method of the present invention produces glass blades with a cutting edge that has a sharpness that is comparable to those achieved on metal blades.

To this end, the present invention provides a method of manufacturing a glass blade with a cutting edge, said method comprising the steps of: a) providing a strip of glass with a leading end and a trailing end; b) feeding a predetermined length of the glass strip along a longitudinal path between a pair of opposing rollers, wherein a first roller, which is vertically adjustable, contacts a first surface of the glass and a second roller, which is vertically fixed, contacts a second surface of the glass at a location closer to the leading end of the glass strip than the first roller; c) scoring the first surface at least partially across the width of the glass strip to form a score line located downstream of the rollers but upstream of the leading end of the strip; and d) applying a breaking force to the first surface of the glass strip at an impact site located between the score line and the leading end such that the glass strip breaks along the score line, wherein the horizontal component of the breaking force is directed away from the rollers.

Rather than cutting the glass to give it a cutting edge, the method of the present invention creates a glass blade by effectively breaking the glass strip in a controlled manner that takes advantage of the innate properties of glass to form a fine cutting edge on the glass blade that is broken off the glass strip.

The location of the cutting edge, and thus the size of the glass blade, is defined by the position at which the score line is formed in the glass strip. The score line creates a point of weakness that breaks when the breaking force is applied to the leading end of the glass strip whilst the trailing end of the glass strip is retained between the rollers.

The inventor surprisingly found that providing the first roller with the ability to move upwards when the breaking force impacts on the portion of the glass strip upstream of the score line enables the main body of the glass strip, which is upstream of the score line, to pivot about the second roller in a direction contrary to the upstream portion.

The contrary pivoting movement of the glass strip on either side of the score line caused by the combined action of the breaking force and the rollers effectively pulls the two parts of the glass strip away from one another as the glass breaks. This action leads to the formation of a fine cutting edge on the upstream portion of the glass strip, which in turn delivers the glass blade of the present invention.

Although it will be appreciated by the skilled person that a breaking force with the required horizontal component can be delivered in a number of ways, it is considered preferable that the breaking force is imparted on the leading end of the glass strip by the head of a pivotably mounted hammer.

Further preferably, the width of the hammer head may be equal to or greater than the width of the glass strip. It is envisaged that adopting a hammer head that applies the breaking force across the entire width of the glass strip means that the score line does not necessarily need to extend across the entire width of the glass strip to achieve a clean break.

Preferably the hammer head may comprise a material capable of applying a griping force to the surface of glass. It is appreciated that improving the grip of the hammer when it impacts on the glass strip helps to further enhance the extent to which the horizontal component of the breaking force is applied to the glass. This improved the extent to which the upstream portion of the glass strip is pulled away from the downstream portion of the glass strip. Further preferably the gripping material provided on the hammer head may be a rubber, such a polyurethane rubber.

Preferably at least one of the rollers may have a width that is equal to or greater than the width of the glass strip.

Preferably at least one of the rollers may comprise a material capable of applying a gripping force to the surface of the glass. Once again, it is appreciated that improving the grip of the rollers on one or both surfaces of the glass strip helps to further enhance the extent to which the downstream portion of the glass strip is pulled away from the upstream portion of the glass strip. Further preferably the gripping material provided on the rollers may be a rubber, such a polyurethane rubber.

Preferably the first surface may be scored across the entire width of the glass strip.

Preferably the glass strip may be float glass. Float glass is considered to be particularly suitable because the consistent formation of the glass ensures a regular breaking action of the glass strip. Further preferably the float glass may have a patterned/textured surface and said score line is formed in the non-patterned/textured surface of the glass strip.

It has been found that the pattern/texture in the surface of the glass causes the cutting edge of the glass blade to be provided in a discontinuous form because of the variations in the glass thickness that give the glass its patterned/textured surface. In particular, the fine sharp edges are only formed in the thinner regions of the glass strip.

It has been found that the discontinuous cutting edge renders the blade less sharp to the direct touch, whilst still providing a cutting effect when the blade is drawn across an object. It is envisaged therefore that glass blades formed from patterned/textured float glass has a further safety aspect.

Preferably the score line may be formed a distance of between 20 and 30 mm from the leading end of the glass strip. It is envisaged that this positioning of the score line delivers a glass blade of suitable size for use in preferred applications such as glass razor blades for styling razors.

Preferably the glass strip may have a thickness of between 0.4 and 25 mm.

Preferably steps b) to d) are repeated a plurality of times to produce multiple glass blades from the same glass strip. In this way, the method of the present invention can be employed to manufacture a large number of glass blades in a relatively short period of time.

The present invention also provides an apparatus for making glass blades with a cutting edge in accordance with the method of the present invention. The apparatus comprising: a feeding mechanism having a pair of longitudinally offset rollers arranged to contact opposing surfaces of a glass strip and thereby control the positioning of the glass strip relative to a target location, wherein a first of said rollers, which contacts a first surface of the glass strip, is vertically adjustable to permit the glass strip to pivot about a second vertically fixed roller; a scoring tool located downstream of the first and second rollers, said tool being operable to score a line in the first surface of the glass strip at a location adjacent to and upstream of the target location; and a glass breaking mechanism having a pivotably mounted hammer configured to deliver a breaking force to a region of the first surface of the glass strip positioned at the target location, wherein the horizontal component of the impact force is directed away from the rollers.

Preferably the rollers may be passive and the glass strip feeding mechanism further comprises an actuation system that is configured to urge the glass strip between the rollers towards the target location. Alternatively, at least one of the rollers is driven to urge the glass strip through them towards the target location.

Preferably the second roller may be horizontally adjustable to enable the distance between the pair of rollers to be changed. It is envisaged that adjusting the lateral distance between the first and second rollers would change the extent to which the upstream portion of the glass strip is able to pivot about the second roller when the hammer applies the breaking force.

Preferably at least one of the rollers may be provided with a glass contact surface that comprises a material capable of applying a gripping force to the surface of the glass. Additionally or alternatively the hammer may be provided with a glass impact surface that comprises a material capable of applying a gripping force to the surface of the glass. Further preferably the material used to grip the surface of the glass may be a rubber, such as a polyurethane rubber.

As noted above, it is envisaged that increasing the grip of the roller(s) and/or the hammer helps to enhance the extent to which to upstream and downstream portions of the glass strip are pulled apart when the hammer applies the breaking force to the target location.

Preferably the scoring tool may comprise a tungsten carbide scoring wheel.

Preferably the glass feeding mechanism, the scoring tool and/or the glass breaking mechanism may be hydraulicly operated. Alternatively, the scoring tool and/or the glass breaking mechanism may be pneumatically operated.

### BRIEF DESCRIPTION OF THE DRAWINGS

The present invention will now be described with reference to the preferred embodiments shown in drawings, wherein:

FIG. 1 shows a diagrammatic representation of the key stages of a preferred embodiment of the glass blade manufacturing method of the present invention;

FIG. 2 shows a perspective view of a preferred embodiment of the glass blade making apparatus of the present invention;

FIG. 3 shows a further perspective view of a preferred embodiment of the glass blade making apparatus of the present invention;

FIG. 4 shows a cross-sectional view of the glass blade making apparatus shown in FIGS. 2 and 3;

FIG. 5 shows a plan view of a glass blade manufactured using the method and apparatus of the present invention;

FIG. 6 shows a side view of the glass blade shown in FIG. 5;

FIG. 7a shows a x5 magnified view of the cutting edge of the glass blade shown in FIGS. 5 and 6;

FIG. 7b shows a x50 magnified view of the cutting edge of the glass blade shown in FIGS. 5 and 6; and

FIG. 8 shows a preferred embodiment of a styling razor with a glass blade of the present invention.

### DETAILED DESCRIPTION OF THE PREFERRED EMBODIMENTS

The present invention provides a method of manufacturing a glass blade with a razor-sharp cutting edge. Without being drawn on a theory, the inventor believes that the method utilises the fluid-like properties of glass to achieve a fine edge that gives the glass blade of the present invention with its razor-sharp cutting edge. Before describing the present invention in detail therefore, it is considered beneficial to first briefly consider the unusual qualities of glass as a material.

Unlike most solid materials, in which the material's molecules are arranged in a regular crystal lattice, the molecules in glass (the majority of which is SiO₂) are much less organised. This intramolecular arrangement is a result of the way in which glass is made. In view of its unusual qualities glass is characterized as an amorphous solid.

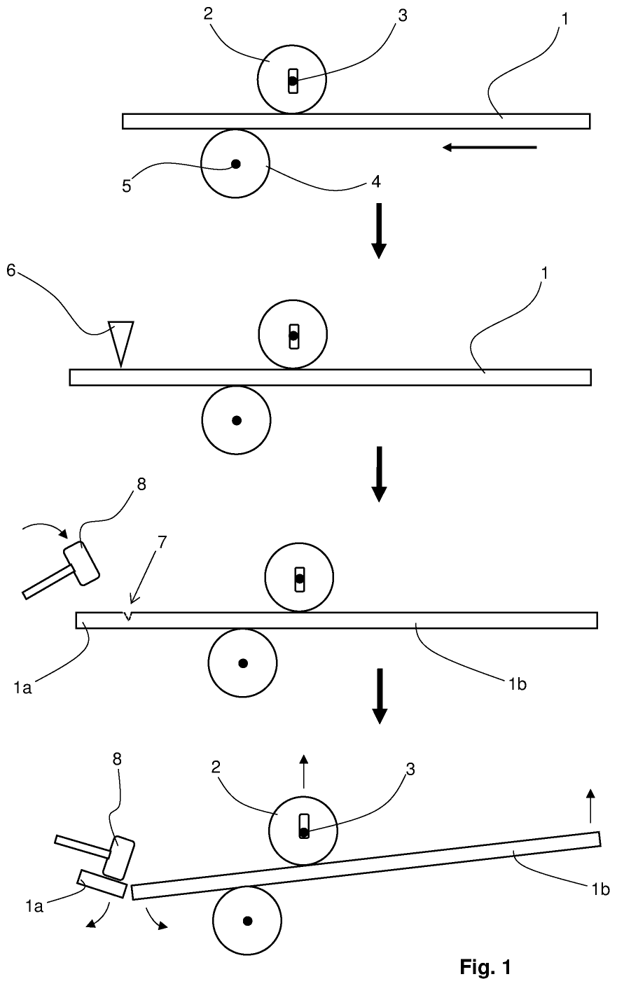

Turning now to the method of the present invention, the key stages of the glass blade creation are shown in diagrammatic form in FIG. 1.

It is envisaged that the glass strip 1 used to form the glass blades of the present invention is longer than it is wide and wider than it is thick. Preferably the glass strip is float glass with a thickness of between 0.4 to 25 mm, and further preferably between 3-7 mm thick. Preferably the glass strip will be between 20 to 40 mm wide.

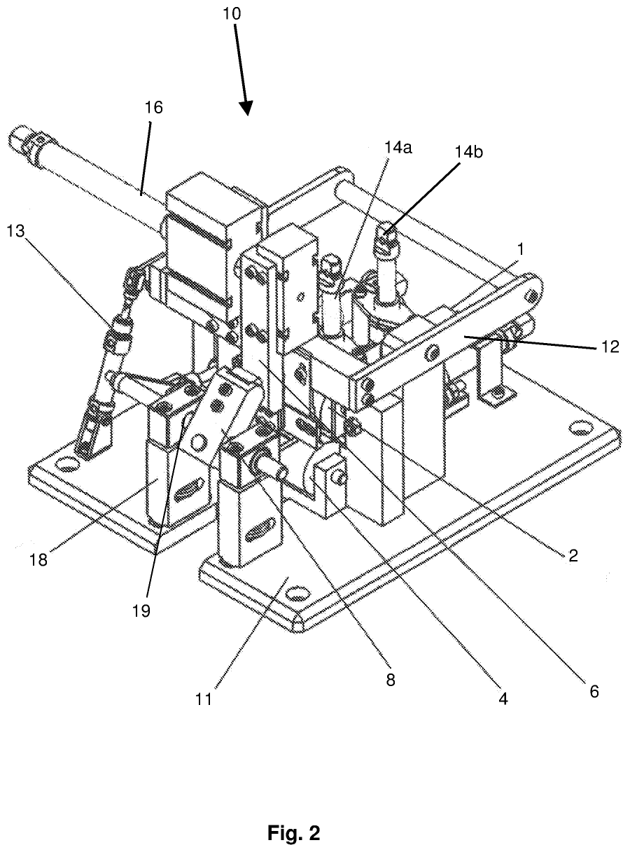

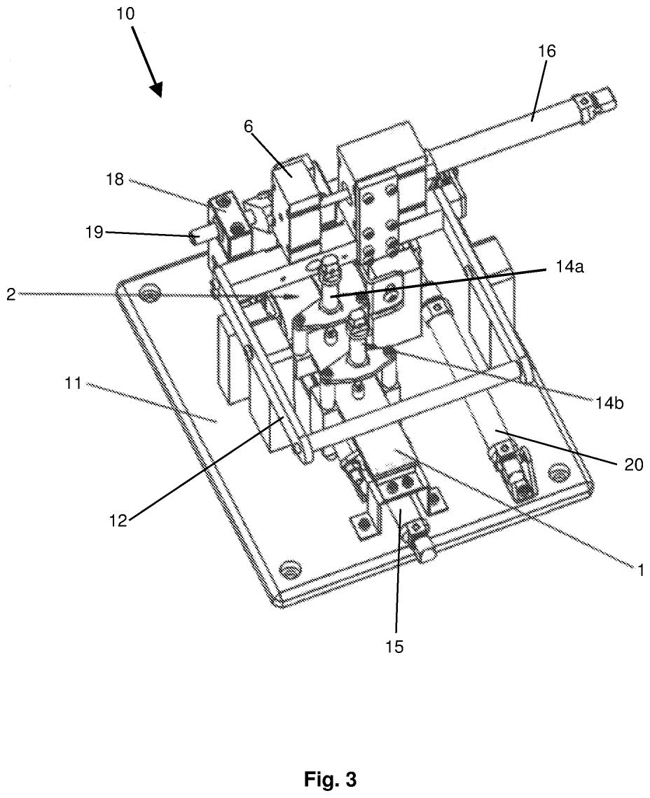

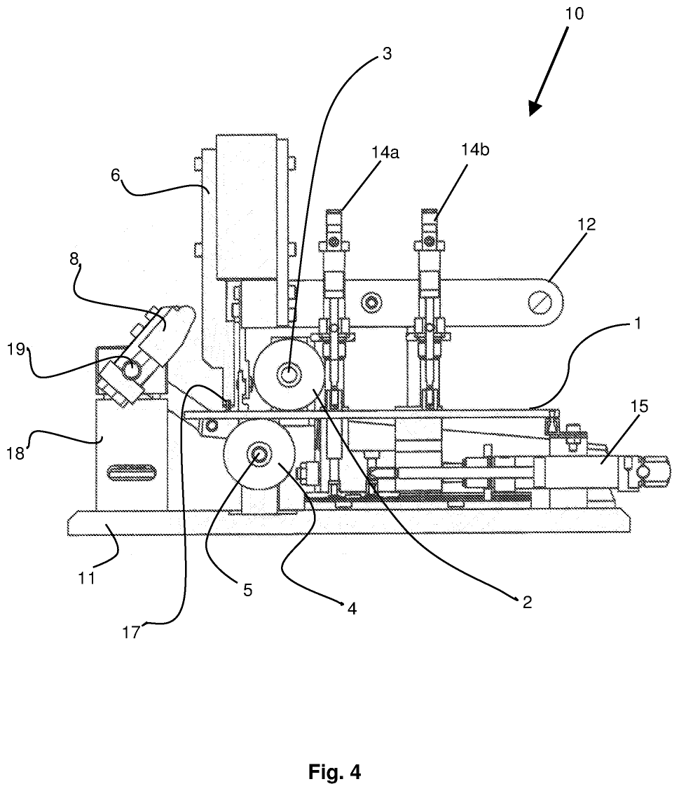

The preferred proportions of the glass strip 1 will be better appreciated from FIGS. 2 to 4, which show the glass strip 1 in situ within a preferred embodiment of the glass blade making apparatus 10 of the present invention.

In the first stage glass strip 1 is fed between a pair of laterally offset rollers 2, 4 such that each roller contacts an opposing surface of the glass strip. In particular, the upper roller 2, which is mounted on pivot 3, engages the top surface of the glass strip 1 and the lower roller 4, which is mounted on pivot 5, engages the underside of the glass strip 1.

The upper roller 2 is mounted such that it has the freedom to move upwards away from the lower roller 4. This vertical adjustability is represented in FIG. 1 by way of a slot, but it will be appreciated by the skilled person that this vertical adjustability could be achieved in a number of ways. It is envisaged that the weight of the roller 2 will be sufficient to urge the roller into contact with the top of the glass strip. However, resilient biasing means may also be employed to achieve this, provided they do not prevent the roller 2 from moving upwards when the breaking force is applied.

In contrast to the upper roller 2, the lower roller 4 is fixed so that it has no freedom of movement in a vertical plane. With that said, it is considered preferable that the lower roller 4 may be mounted so at to give it horizontal adjustability so that the horizontal spacing between pivots 3 and 5, and therefore rollers 2 and 4, can be controlled by an operator.

Although it is also envisaged that the upper roller 2 could have horizontal adjustability too, from a design point of view it is easy to achieve any desired change in the intra roller spacing (i.e. from pivot 3 to pivot 5) by simply moving the lower roller 4.

Returning now to the first stage of the method, the glass strip 1 is fed between the rollers 2, 4 by a feeding mechanism until a predetermined length of glass extends beyond the rollers.

Although it is envisaged that the passage of the glass between the rollers 2, 4 could be achieved by incorporating drive means into the rollers, it is considered preferable that the rollers are passive and a glass strip is pushed through them by an actuation system.

Preferably at least one of the rollers 2, 4 has an outer surface that grips the glass strip as it passes between the rollers. One way of giving the rollers a gripping surface is to employ a rubber material, such as polyurethane rubber. The rubber could be added as a coating on the outside of the roller, or it could be used to form the entire roller body.

Once the glass strip 1 has been fed through the rollers by a predetermined distance the strip 1 comes to rest with its leading end extending beyond scoring tool 6. Preferably the length of the portion of the glass strip 1 that extends beyond the location of the scoring tool is between 20 and 30 mm. It will be appreciated that this distance essentially serves to determine the size of the glass blade formed by the process.

The scoring tool 6, which is preferably a tungsten carbide wheel, is operated to score a line 7 in the upper surface of the glass strip 1. The score line 7 is oriented perpendicular to the longest axis of the glass strip 1 (i.e., across the width of the glass strip). With that said, it is envisaged that the score line 7 does not necessarily need to extend across the entire width of the glass strip 1.

The purpose of the score line 7 is to create a point of weakness in the glass strip about which the glass can be broken. As such, the score line 7 does not need to cut deep into the glass, it merely needs to be sufficient to create a point of weakness in the glass.

The score line 7 serves to partition the glass strip 1 into two portions, namely the leading or downstream portion 1a and the trailing or upstream portion 1b. As will now be appreciated, it is the downstream portion 1a that is broken off to form the glass blade in the final step of the method.

In the final step a breaking means, which in the preferred embodiment takes the form of a pivotably mounted hammer 8, is operated to apply a breaking force onto the upper surface of the downstream portion 1a of the glass strip 1.

The path of the swing of the pivoted hammer 8 is such that the breaking force applied to the upper surface of the glass strip has a horizontal component that is directed away from the rollers 2, 4 and the upstream portion of the glass strip 1b. This causes the downstream portion 1a of the glass strip 1 to be pivoted away from upstream portion of the glass strip 1b.

As the same time, because the upper roller 2 is free to move upwards (i.e. due to its vertical adjustability), the trailing end of the upstream portion of the glass strip 1b is capable of moving upwards about the pivot point of the vertically fixed lower roller 4. This action causes the upstream portion 1b of the glass strip 1 to be pivoted away from downstream portion 1a of the glass strip 1 when the hammer strikes the glass strip.

It is appreciated that providing the rollers 2, 4 with a glass gripping surface helps to enhance the extent to which the upstream portion 1b of the glass strip 1 is pivoted away from downstream portion of the glass strip 1a when the hammer 8 strikes the glass strip. A similar enhancement can be achieved for the downstream portion of the glass strip 1a by applying a gripping surface (e.g., polyurethane rubber) on the head of the hammer 8.

A preferred embodiment of the glass blade making apparatus 10 of the present invention will now be described with reference to FIGS. 2, 3 and 4. Those features of the apparatus 10 that correspond with the features shown in diagrammatic form in FIG. 1 have been identified with the same reference numbers for the sake of consistency.

The apparatus 10 is provided with a base 11 upon which all of the working components of the apparatus are mounted. Offset rollers 2 and 4 are held within a frame 12 that is mounted on the base 11 and supported by bracket 13.

The upper roller 2 of the apparatus 10 is engaged with the frame 12 in such a way that the roller 2 is capable of travelling up and down within a vertical pathway (i.e. the roller is vertically adjustable) relative to the frame 12, and therefore the lower roller 4, which is not free to move up and down in a vertical direction.

As the rollers 2, 4 in apparatus 10 are passive, a hydraulically actuated feeding mechanism is employed to feed the glass strip 1 through the rollers towards the scoring tool 6 and the hammer 8. It will be appreciated that, although the described embodiment employs hydraulics, pneumatically may also be employed either as an alternative or in combination with the hydraulics to actuate the mechanisms of the described apparatus.

The feeding mechanism comprises a system of actuators 14a, 14b and 15, which are preferable provided as hydraulically operated pistons, that work together to periodically urge the glass strip through the rollers by a predetermined amount. Vertical actuators 14a and 14b both engage with the top surface of the glass strip, but each actuator being periodically disengaged from the glass during the operation of the apparatus.

In order to urge the glass strip through the rollers, actuator 14a engages the top surface of the glass strip and actuator 14b disengages the glass strip. At the same time, horizontal actuator 15, which is operatively connected to actuator 14a, moves to urge actuator 14a and the glass strip 1 forward by a predetermined amount.

Actuator 14a then disengages the glass strip as actuator 14b re-engages with the glass strip 1. Once actuator 14b has engaged with the glass strip 1, actuator 15 returns actuator 14a to its start position. Actuator 14a then re-engages with the glass strip 1 and the process begins again. By way of this mechanism the glass strip is repeated feed through the rollers to be processed further.

In order to score a line in the upper surface of the glass strip 1 prior to the breaking step, the apparatus 10 is provided with a scoring tool 6, which preferably takes the form of a tungsten carbide wheel 17. It is appreciated that other cutting devices capable of scoring a line in the surface of glass could alternatively be employed without departing from the general scope of the present invention.

The scoring tool 6 is slidably mounted on the frame 12 and is hydraulically actuated by actuator 16 to periodically move across the glass strip 1 in a direction that is perpendicular to the direction of travel of the glass strip (i.e. across the width of the glass strip).

In this way, once a predetermined length of the glass strip has been feed through the rollers 2,4 by actuators 14a, 14b, 15 of the feeding mechanism, the scoring tool 6 scores a line in the upper surface of the glass strip 1 at a location downstream of the rollers but upstream of the hammer 8.

Preferably the score tool 6 travels across the entire width of the glass strip 1 and creates a score line 7 that extends from one side of the glass strip 1 to the other. However this is not considered to be essential provided the head of the hammer 8 is wide enough to contact with the entire width of the glass strip 1.

Once the score line 7 has been cut into the glass strip 1, the apparatus 10 moves on to the breaking step, in which the hammer 8 is used to break the leading end of the glass strip from the rest of the glass strip 1. The hammer 8 is pivotably mounted between two columns 18 on axle 19. The columns 18 in turn extend from the base 11.

The head of the hammer 8 comprises a gripping surface, which, as already noted, may take the form of either a rubber coating or indeed the head could be formed entirely from rubber.

An example of a suitable rubber is polyurethane rubber, but the skilled person will appreciate that alternative material could be employed to give the hammer head the ability to form a better grip on the glass of the glass strip.

The action of the swinging hammer 8 is hydraulically actuated via axle 19 by actuator 20 so that the head of the hammer 8 strikes the portion of the glass strip that is located downstream of the score line 7. Once again, the actuator preferably takes the form of a hydraulically operated piston.

The columns 18 position the hammer 8 relative to the glass strip 1 such that when the hammer 8 pivots it imparts a breaking force on the upper surface of the glass strip that has a horizontal component that is directed away from the rollers 2, 4.

As explained above, the breaking force applied to the downstream portion of the glass strip 1a is such that the leading end of the glass strip is caused to pivot away from the rest of the glass strip engaged by the rollers, (i.e. the portion of the glass strip 1b that is upstream of the score line 7).

At the same time, because the upper roller 2 is free to move upwards, the upstream portion of the glass strip 1b pivots away from the downstream portion 1a in a contrary direction.

The inventor believes that it is the contrary pivoting action of the glass portions on either side of the weakened point created by the score line 7 that results in the formation of a fine edge on the downstream portion of the glass strip, which gives the glass blade of the present invention with a cutting edge.

Once the glass blade (i.e. the downstream portion of the glass strip 1a) has been broken off the rest of the glass strip, the whole process will begin again with the glass strip being urged through the rollers 2, 4 towards the scoring tool 6.

Although the glass strip shown in situ in FIGS. 2, 3 and 4 is shown as being an untextured strip of glass, it is considered advantageous for the glass strip to be provided in the form of patterned or textured float glass. The pattern/texture is achieved by raised, and therefore thicker, regions of glass that extend from one surface of a glass sheet.

The glass is inserted into the apparatus with patterned/textured side facing downwards. This ensures that the cutting edge is formed adjacent to the raised sections of the glass that give it a patterned/textured appearance.

In this regard it has been surprisingly found that using the method and apparatus of the present invention to form glass blades from a strip of patterned or textured float glass produces a glass blade that, unlike the glass blades formed from untextured glass, is only sharp at certain points along its edge.

In particular, the sharp edges are formed in the regions where the patterned/textured surface is not raised. That is to say, the regions of the glass where it is at its thinnest.

In has been found that there are safety benefits to glass blades formed in this way because the cutting edge of the blade is essentially shielded by the thicker, and therefore duller, portions of the blade's edge.

Testing has shown that whilst a glass blade formed in accordance with the present invention using patterned/textured glass is capable of having a cutting effect when it is drawn across an object, the cutting effect is dulled when a pressure is applied to the glass blade in a direction perpendicular to the cutting edge. This makes the glass blades formed from textured/patterned glass easier to handle.

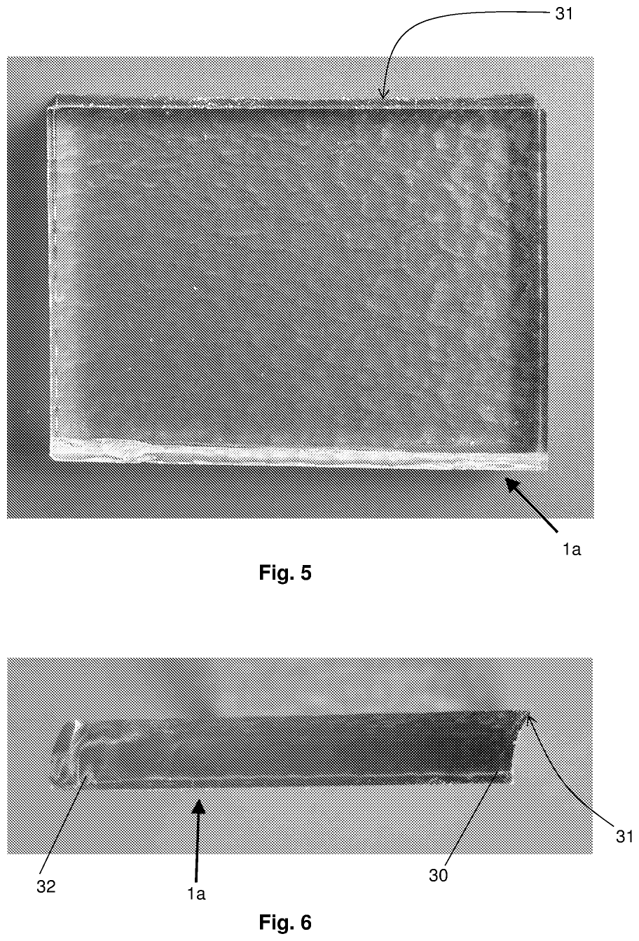

FIGS. 5, 6, 7a and 7b show various views of a preferred embodiment of the glass blade 1a of the present invention.

FIG. 5 shows the glass blade 1a in plan such that the cutting edge 30 and the textured glass is visible. The irregular shape of the cutting edge 30, which is formed due to the varying thickness of the patterned/textured glass, is clearly discernible at the top of the glass blade 1a.

From FIG. 6, which shows the glass blade 1a from the side, it is possible to appreciate the characteristic shapes of both the leading end 30, with its cutting edge 31, and the trailing end 32 that are formed as a consequence of the glass blade 1a being formed from a glass strip 1 (see FIG. 1) using the process of the present invention.

As can also be appreciated from the figures, the leading end 30 has a concave shape and the trailing end has a corresponding convex shape. The cutting edge 31 is located adjacent to the patterned/textured side of the glass blade 1a.

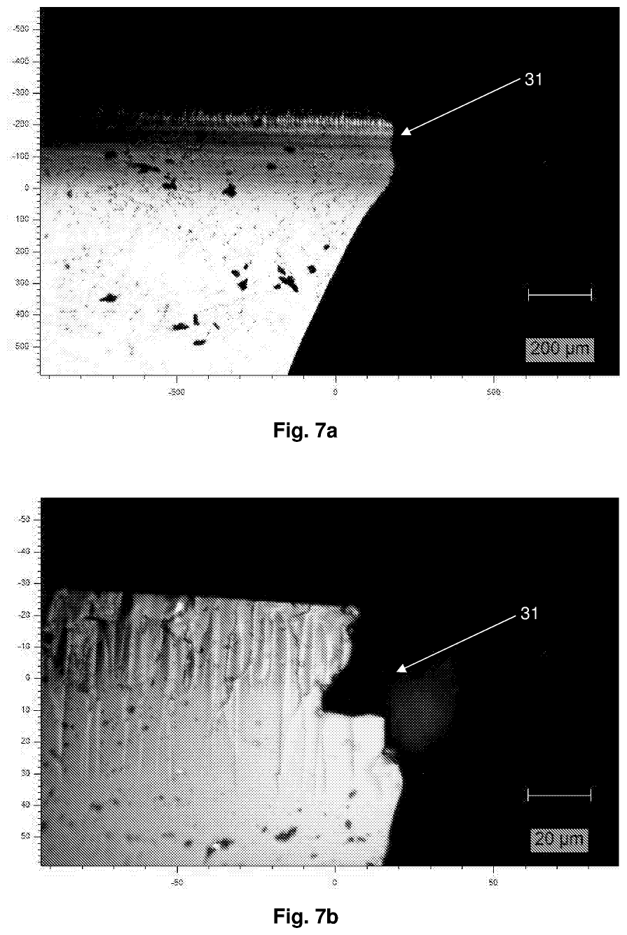

The cutting edge 31 imparted on the glass blade by the manufacturing process of the present invention can be further appreciated from the magnified views of the leading end 30 shown in FIGS. 7a and 7b.

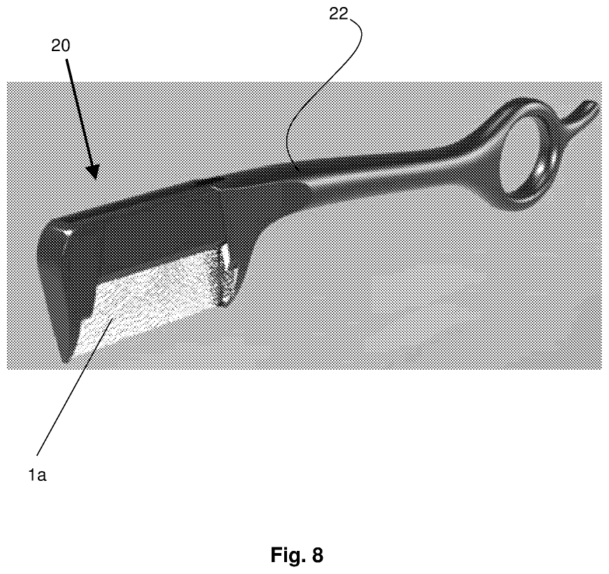

It is envisaged that the glass blades of the present invention can be received in a handle assembly to facilitate the use of the glass blade in cutting operations. FIG. 8 shown an example of a glass blade 1a of the present invention held within a handle 22 to form a styling razor 21.

The glass blade 1a is removably received within the handle 22 so that, once the blade's cutting effectiveness recedes, the user can simply replace the glass blade 1a with a new one. The old glass blade can then be placed into the domestic glass recycling stream.

It is envisaged that the glass blades of the present invention could have a wide range of applications. One particularly suitable application is in personal grooming equipment such as shaving blades, facial razors, eyebrow razors, and microblading blades.

The glass blades could also be employed in medical applications such as surgical blades due to the fact that glass can be readily sterilised using existing sterilisation methods (e.g., autoclaves).

The glass blades of the present invention could also be used in general cutting implements, such as utility knives, craft knives and as scissor blades, and in more specialised implements, such as leather skivers.

1. A method of manufacturing a glass blade with a cutting edge, said method comprising the steps of:
a) providing a strip of glass with a leading end and a trailing end;
b) feeding a predetermined length of the glass strip along a longitudinal path between a pair of opposing rollers, wherein a first roller, which is vertically adjustable, contacts a first surface of the glass and a second roller, which is vertically fixed, contacts a second surface of the glass at a location closer to the leading end of the glass strip than the first roller;
c) scoring the first surface at least partially across the width of the glass strip to form a score line located downstream of the rollers but upstream of the leading end of the strip; and
d) applying a breaking force to the first surface of the glass strip at an impact site located between the score line and the leading end such that the glass strip breaks along the score line, wherein the horizontal component of the breaking force is directed away from the rollers.

2. The method of claim 1, wherein the breaking force is imparted on the glass by the head of a pivotably mounted hammer.

3. The method of claim 1 wherein the width of the hammer head is equal to or greater than the width of the glass strip.

4. The method of claim 2 wherein the hammer head comprises a material capable of applying a griping force to the surface of glass.

5. The method of claim 1, 2, 3 or 4, wherein at least one of the rollers has a width that is equal to or greater than the width of the glass strip.

6. The method of claim 1, wherein at least one of the rollers comprise a material capable of applying a gripping force to the surface of the glass.

7. The method of claim 4 wherein the material used to grip the surface of the glass is a rubber, such as a polyurethane rubber.

8. The method of claim 1, wherein the first surface is scored across the entire width of the glass strip in step c).

9. The method of claim 1, wherein the glass strip is float glass.

10. The method of claim 9, wherein the float glass has a patterned/textured surface and said score line is formed in the non-patterned/textured surface of the glass strip.

11. The method of claim 1, wherein the score line is formed a distance of between 20 and 30 mm from the leading end of the glass strip.

12. (canceled)

13. (canceled)

14. A glass blade formed by the method of claim 1.

15. An apparatus for making glass blades with a cutting edge, said apparatus comprising:
a feeding mechanism having a pair of longitudinally offset rollers arranged to contact opposing surfaces of a glass strip and thereby control the positioning of the glass strip relative to a target location, wherein a first of said rollers, which contacts a first surface of the glass strip, is vertically adjustable to permit the glass strip to pivot about a second vertically fixed roller;
a scoring tool located downstream of the first and second rollers, said tool being operable to score a line in the first surface of the glass strip at a location adjacent to and upstream of the target location; and
a glass breaking mechanism having a pivotably mounted hammer configured to deliver a breaking force to a region of the first surface of the glass strip positioned at the target location, wherein the horizontal component of the impact force is directed away from the rollers.

18. The apparatus of claim 15 wherein rollers are passive and the glass strip feeding mechanism further comprises an actuator that is configured to urge the glass strip between the rollers towards the target location.

19. (canceled)

21. The apparatus of claim 15, wherein at least one of the rollers is provided with a glass contact surface that comprises a material capable of applying a gripping force to the surface of the glass; and wherein preferably the material is rubber and further preferably polyurethane rubber.

22. The apparatus of claim 15, wherein the hammer is provided with a glass impact surface that comprises a material capable of applying a gripping force to the surface of the glass; and wherein preferably the material is rubber and further preferably polyurethane rubber.

23. The apparatus of claim 15, wherein the scoring tool comprises a tungsten carbide scoring wheel.

24. The apparatus of claim 15, wherein the glass feeding mechanism, the scoring tool and/or the glass breaking mechanism are hydraulicly operated.

25. A styling razor comprising the glass blade of claim 14.
